(19) United States
(12) Patent Application Publication
(10) Pub. No.: US 2016/0080173 A1
(43) Pub. Date: Mar. 17, 2016

(54) COMPLEX EVENT PROCESSING AS DIGITAL SIGNALS

(71) Applicant: EBAY INC., San Jose, CA (US)

(72) Inventors: Sterling Ryan Quick, Fredericksburg, VA (US); Armand Nobert Kolster, San Jose, CA (US)

(21) Appl. No.: 14/586,880

(22) Filed: Dec. 30, 2014

Related U.S. Application Data
(60) Provisional application No. 62/050,741, filed on Sep. 15, 2014.

(51) Int. Cl. H04L 25/02; G06Q 30/02

(52) U.S. Cl. CPC H04L 25/02; G06Q 30/0202

(57) ABSTRACT

Devices, systems and/or methods are provided to implement true real time pattern recognition and anomaly detection by leveraging hardware specifically designed for that purpose. In particular, digital signal processors (DSPs) are used to provide true real time analysis of digital signals. In an embodiment, the system may convert the CEP stream itself to a format understood by the hardware components while retaining enough specificity to reference particular events for further processing and analytics, resulting in true real time performance for CEP.

### CROSS REFERENCE TO RELATED APPLICATION

Pursuant to 35 U.S.C. §119(e), this application claims priority to the filing date of U.S. Provisional Patent Application Ser. No. 62/050,741, filed Sep. 15, 2014, which is incorporated by reference in its entirety.

### BACKGROUND

1. Field of the Invention

The present invention generally relates to devices, systems, and methods for implementing complex event processing.

2. Related Art

Complex Event Processing (CEP) is a method of tracking and analyzing or processing streams of information or data about occurring events and deriving conclusions from them. CEP may combine data streams from a plurality of different sources and analyze them as quickly as possible to identify meaningful events. Traditionally, complex event processing works by leveraging text search and correlation on general purpose CPUs in software. The approach can leverage either scale-out distributed or large-scale vertical deployments to provide low-latency or in-depth analysis, respectively. However, the traditional text-based approach is limited to analyzing events in the past as the text representation of an event must be codified and analyzed with tools which only recognize text as complete units. As such, traditional approaches to complex event processing solutions cannot provide real-time analyses because they must understand events in packets. For example, in human speech one must hear an entire sentence, or at least its constituent parts before being able to make a determination as to the intelligibility of the words in that sentence. This means that the analysis is always performed after the words are received, and as such can only be performed in the past. Likewise traditional text analysis methods using things like search, parts of speech, natural language analysis, jargon analysis, and even normalized schematic events all require the full context of a “packet of knowledge” before becoming comprehensible. So the best systems can operate near real-time, at very high expense.

Traditional systems often make sacrifices around the depth of analysis in order to provide more real-time response. For example, broad systems may look at a network of 8 or 10 related metrics which can return a response in less than a second instead of looking at 20 or 30 which may provide a more comprehensive response but not within tolerated performance service level agreements. Thus, there is a need for a system that provides real time and in-depth and comprehensive analysis in complex event processing.

### BRIEF DESCRIPTION OF THE FIGURES

FIG. 1 is a block diagram of a networked system suitable for implementing complex event processing according to an embodiment.

FIG. 2 is a flowchart showing a process for setting up digital signal filters for complex event processing according to one embodiment.

FIG. 3 is a flowchart showing a process for executing complex event processing as digital signals according to one embodiment.

FIG. 4 is a block diagram of a computer system suitable for implementing one or more components in FIG. 1 according to one embodiment.

FIG. 5 is a block diagram showing a system for complex event processing according to one embodiment.

FIG. 6 is a process flowchart for event information processing according to one embodiment.

FIG. 7 is a process flowchart for processing incoming event information according to one embodiment.

FIG. 8 is diagram showing an exemplary data structure of event information according to one embodiment.

FIG. 9 is a diagram showing analysis of event information according to one embodiment.

FIG. 10 is a diagram showing parallel processing of multiple event streams according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Complex Event Processing (CEP) involves taking Big Data analytics, combining it with the constant barrage of new information, and augmenting the resulting concepts and relationships with a variety of data sources. Traditionally, CEP involves text analysis: search, natural language analysis, principal component analysis, feature extraction, and the like. Because conventional event analysis of events requires sets of text and values in containers which can be understood in groups, conventional work is always performed on the past. That is to say, that understanding “now” cannot be done since there is nothing to describe “now” until after “now” happens. This means that reaping value from immediate events that matter depends on the speed of pattern recognition and anomaly detection and is directly proportional to the speed at which event messages can be consumed and analyzed.

There are essentially two designs by which CEP happens in current technology: scale-out systems designed to analyze very wide streams for specific markers and relatively small, contained analytics, or scale-up vertical systems designed to perform deep analysis on a relatively narrow stream. Neither of these architectures can provide true real time performance. Once events are received, they must be codified and analyzed in software, then those events must be augmented to derive the insight needed from the classification and processing steps. Interdependent and often convoluted workflows tend to be the norm for both scale-out and scale-up designs—resulting in longer latency and more fragility in the overall solution. Thus, there is a need for a system that mitigates one or more of these short-comings of the traditional system.

According to an embodiment of the present invention, devices, systems and/or methods are provided to implement true real time pattern recognition and anomaly detection by leveraging hardware specifically designed for that purpose. In particular, digital signal processors (DSPs) are used to provide true real time analysis of digital signals. DSPs perform well in facial and spatial recognition, biometrics, audio and video production and processing, WiFi security and segmentation, and a variety of other fields.

In an embodiment, the system may convert the CEP stream itself to a format understood by the hardware components while retaining enough specificity to reference particular events for further processing and analytics, resulting in true real time performance and analytics for CEP. Because systems leveraging DSPs for real time processing tend to come in relatively small (from the enterprise datacenter perspective) packages, the cost for the performance boost can actually be lower than the traditional approach in many cases. Usually, when systems architects decide to “bring hardware to bear” on a problem, IT management sees larger capital expenditures in the near future. The phrase implies either a “bigger, tougher, wider network” or a “bigger, tougher box”. Hence the scale-out and scale-up solutions to the CEP problem we see in common use today.

The DSP-enhanced architecture takes much of the workload from central processors into purpose built cores. As a result, the operating system has little to do beyond managing IO and surfacing anomalies to other applications for further processing. In some testing, ARM cores are leveraged for the operating system since the performance easily delivers these simple requirements. Offloading pattern recognition to DSP cores in the ARM system on a chip (SOC) allows the system to perform real time recognition at a fraction of the space and power requirements of traditional implementations. Coupling an efficient event routing and messaging system both within the SOC and between SOCs and physical systems is also crucial to the overall solution to improve performance and portability.

According to an embodiment, devices, systems, and/or methods are provided to convert streams of event information into formats which can be analyzed in real time with hardware designed for such tasks. In particular, the system may leverage digital signal processors to implement the data analysis process. Other devices, such as a graphics processing unit (GPU), a field programmable gate array (FPGA), a Co-Processor, and even general purpose CPUs depending on which component best matches a task, also may be used for digital signal processing. This may allow for true real-time processing. Implications for applications include fraud/risk, marketing, forecasting, business and systems analytics—anything requiring correlation and analysis of streamed events and patterns. The method radically impacts both performance of analytics as well as cost of operations.

In particular, four core design problems are addressed in the solution: 1). Text conversion to formats for which DSPs have unique affinity; 2). Messaging for incoming and outgoing events between physical systems within the SOC and its components (ARM cores, DSP cores, shared memory); inter process communication (IPC) and remote processing communication (RPC) for event and object brokering between pattern recognition and event handlers. 3). Insight reporting for the efficacy, efficiency, performance, and behavior of CEP processing itself; and 4). Memory management for stream windowing in both distributed and local CEP analytics.

Traditionally, complex event processing for text utilizes standard text processing methods. However, pattern recognition and anomaly detection are typically very processing-intensive and repetitive operations involved in standard text processing. As such, in an embodiment, a system is provided that may offload pattern and anomaly detection into hardware specifically designed to perform pattern recognition and anomaly detection. To do so, the system may convert text into formats traditionally used in digital signal processing (for example audio, video, image processing, etc.). At the same time, the system may maintain the specificity of particular data objects by linking their unique attributes in a scalable, high performance manner with their converted pattern information. The system may then feed the pattern through digital signal processing systems and reserve traditional compute resources for handling anomalies instead of detecting them. This results in a much more efficient use of resources, consumption of resources which are less expensive than traditional compute resources, and decreases the latency from event reception to analysis. Accordingly, the system may provide real-time text analysis of complex event stream in true real-time.

This solution may have at least two advantages to existing methods:

a) leverage hardware for pattern anomaly detection by changing text to formats readily consumable as digital signals as opposed to text
b) perform anomaly and pattern detection in parallel with deeper analysis resulting in improved efficiencies and performance for all aspects of the work.

One approach is to convert events into a format which can be analyzed in real time with hardware specifically designed to operate in such a manner. Initially, the system may leverage digital signal processors (DSPs), but also may be extended to leverage GPU, FPGA, Co-Processor, and even general purpose CPUs depending on which component best matches a task. This may allow for true real time processing. The system may be applied to fraud/risk, marketing, forecasting, business and systems analytics, or anything where correlation and analysis of streamed events and patterns is required. The method may radically impact both performance of analytics as well as cost of operations. Further, this solution does not compromise the ability to make in-depth or comprehensive analysis precisely because the system may offload the repetitive and intensive work of pattern and anomaly detection into parallel systems which leverage hardware to perform those operations.

Consider an example from computer vision. Traditionally, with the camera looking at a subway station turnstile entrance taking pictures at specific intervals, the system may perform three different types of analysis. The system may learn the “regulars” by analyzing the video over time (historical); the system may predict the set of people who will appear at the station within a certain interval of time (predictive probability); or the system may compare individuals against past profiles to see if there are matches which may be immediately used to gain a list of “known or unknown” individuals (event mapping).

However the work on these three types of analysis would be done at different times and often by different systems altogether. While the results of the historical analysis and the predictive analysis could be brought to bear to enhance and augment the immediate mapping, they could only be done to the degree that the immediacy of the mapping was not impacted. This is to say that as soon as it takes longer to look up the historical or predicted data than is reasonable for making a match, the overall utility of the system is diminished and in some cases becomes useless.

Leveraging complex event processing as digital signals allows the system to perform the mapping operations at the same time the system performs predictive and historical analysis. Through parallelizing a serial operation, the system may gain speed and steps of analysis without sacrificing or degrading atomic or overall performance. Systems information data flows from a variety of locations: including the application, the systems and hypervisors involved in serving the application, customer feedback, business metrics, and back-office systems and tools. Normally just collecting this information results in several different systems and applications to be able to make sense of what was received. This is common in the enterprise space, and results in many domains of influence and command-and-control for different applications with different foci and customers. The system may combine all the data from different locations, arriving at different rates, and all in different formats by making sense of the notion of the event itself at a higher level, and offloading common aspects of events to low-level processing in purpose-built hardware, such as digital signal processors. At the same time, this frees traditional resources for the work of correlation and deep analysis.

Applying this computer vision technique in the example above to systems information and command and control gives us the same abilities to perform complex operations on historical, predictive, correlative, and generally rich data sets in real time as events are processed. The system may operate in a more efficient manner, leverage fewer resources to accomplish command-and-control as well as to perform the application service, and maintain stricter auditability with more detailed reporting. For example, the application might notice an atomic slowdown in query performance for a particular database. When the performance degradation is not outside tolerance levels, this would not trigger a response from systems management command and control applications and teams. But when coupled with a correlated event from the storage system marking a particular set of disks which serve that same database as degraded, and in conjunction with an increase in the number of queries per second to the application serving the customer during the same time period, the system may immediately recognize wider impact than seen from any individual source of information and react to correct the overall system before any metric goes beyond Service Level Agreement (SLA) tolerations. This melding of disparate data across domains of operational command and control to effect immediate response and remediation is revolutionary for CEP and event correlation.

Real world application for CEP as digital signals may include detecting fraudulent, invalid, failed, or unusual transactions; leveraging immediate information on behavior and location to provide targeted emergency assistance, marketing and sales, shipping and delivery, crowd control, customer support, sentiment analysis, etc; preventing failure and degradation in very large distributed and disparate systems; enhancing ecological, architectural, structural, utility, manufacturing, resource management, or command and control infrastructure.

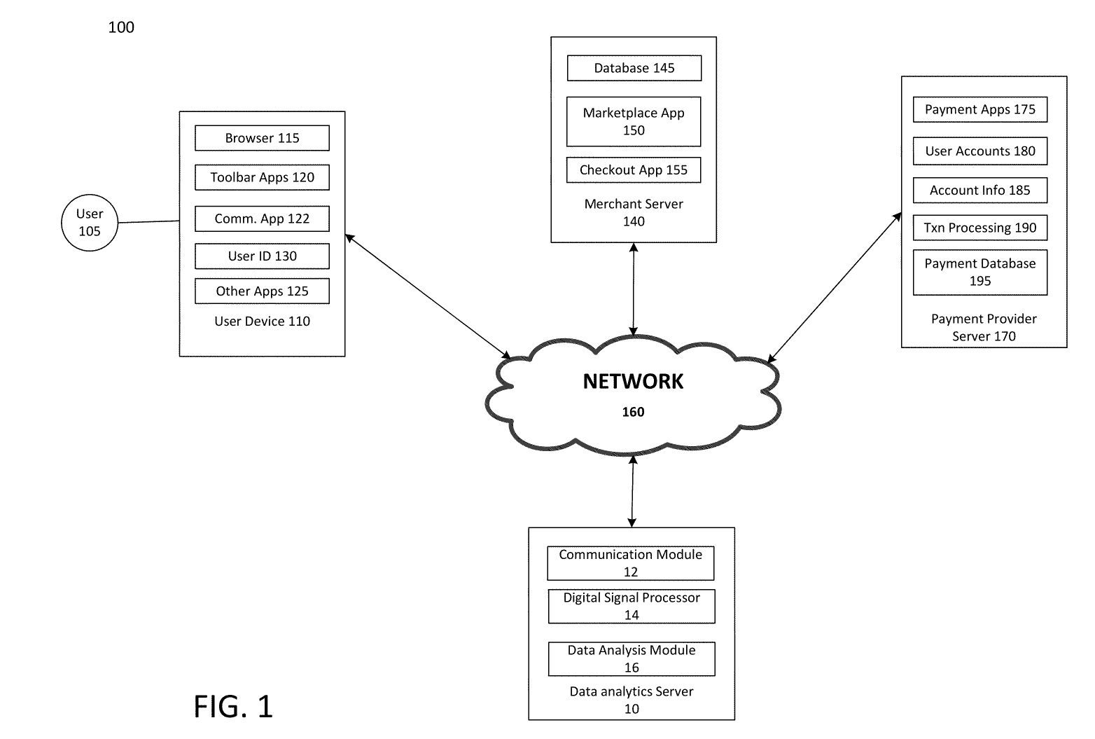

FIG. 1 is a block diagram of a networked system 100 configured to implement CEP as digital signals accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, a payment provider server 170, and a data analytics server 10 in communication over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant.

Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

The data analytics server 10 may collect or gather various event data from the user device 110, the merchant server 140, and the payment provider server 170 to analyze various events occurring at these entities in real time. For example, event data related to communications, emails, web postings, social media interactions and the like that occur at the user device 110 may be captured and streamed to the data analytics server 10 for analysis. Further, event data related to payment transactions, financial transactions, system errors, online visitors, irregular activities or transactions, operation status, and the like that occur at the merchant server 140 or at the payment provider server 170 also may be streamed in real time to the data analytics server 10 for analysis. The data analytics server 10 may collect and analyze the various event data to determine various statistics and/or make decisions on actions that need to be taken for security, fraud prevention, system operation, forecasting, and the like.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, wearable device, laptop computer, and/or other types of computing devices capable of transmitting and/or receiving data, such as an iPhone™ or iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a smart wallet through the payment provider as discussed above.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include applications for collecting location data, such as geo-location data via Global Positioning System (GPS), temperature data, altitude data, humidity data, data regarding device movement, ambient sound data, imaging data via a camera, and etc. Further, geo-fencing or wireless beacon technology may be used to define a location. User device 110 may detect signals from devices that implement geo-fencing or wireless beacon technology. These environmental data may be utilized to determine a location or environment in which user device 110 is located.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a donation to charity. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

Data analytics server 10 may be managed by an operator of an overall data analytics system. Data analytics server 10 may receive event data from one or more of user device 110, merchant server 140, and payment provider server 170 either directly or via network 160. The event data may include various events that occur at or around user device 110, merchant server 140, or payment provider server 170. In an embodiment, network 160 may provide event data related to network events to data analytics server 10. For example, event data generated at user device 110 may include search queries entered by user 105, application executed by user 105, transactions conducted by user 105, and various events happening at user device 110. Event data from merchant server 140 may include online traffic, customer visits, purchase transactions, payment transactions, advertisements, discounts/incentives, and various merchant or commerce related events. Payment provider server 170 may have events related to payments, defaults, fraud, user transactions, user authentications, payment transactions, credit related activities, and any payment related events. Data analytics server 10 may receive streams of these event data from these and various other entities.

Data analytics server 10 may include a communication module 12 configured to receive streams of event data from various devices. Data analytics server 10 also may include a digital signal processor 14 configured to process the data event as digital signals. In an embodiment, digital signal processor 14 may be a specialized microprocessor with architecture optimized for operational needs of digital signal processing. The digital signal processor 14 may be configured to measure, filter, and/or compress continuous analog signals in real time. For example, analog signals, such as audio or video signals, may be converted from analog to digital, manipulated digitally, and then converted back to analog form. In particular, the data events may first be converted into digital signals and then filtered by digital signal processor 14.

The system may apply a number of different algorithms and methods for digital signal processing to data. For example, after converting streaming data into analog frequencies and bandwidths, any of the associated methods including but not limited to Fourier Transformations, bandwidth filtering, linear and bi-linear transforms, etc can be applied. Likewise, data which has been converted into normalized formats may utilize any of the available numerical methods implemented in DSPs. These include matrix manipulation, array slicing, windowing, statistical analysis, and many others. In an embodiment, incoming text is converted to single precision numeric formats and adjusted from discrete time series into frequency. Single precision numerical ranges are normalized to conform to prescribed bandwidth ranges which are then modulated to provide multi-series analysis simultaneously. Data analysis module 16 may include a processor configured to process results from the digital signal processor 14.

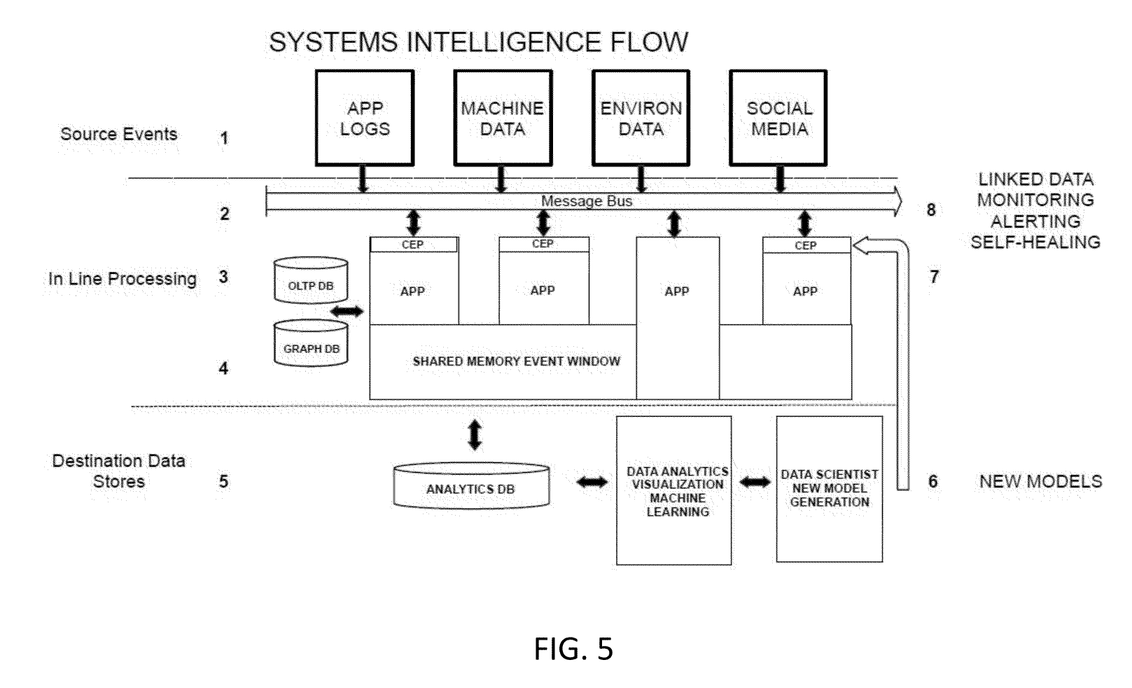

Referring to FIG. 5, a block diagram illustrating a CEP system receiving and processing event information. As shown in FIG. 5, various types of events from various sources, such as Application logs, machine data, environmental data, and social media data, are streamed and fed into the CEP system. CEP system may perform inline processing utilizing multiple applications to analyze the events. The results of the analysis may be output to a data store or other destination. Further, the store data may be analyzed through visualization and machine learning. New models may be generated by users. The new models may be used to improve and update the applications in in-line processing.

In FIG. 5, the digital signal processors (DSPs) may perform inline analytics within the Complex Event Processing function. Because the system is distributed and asynchronous, such an embodiment may employ any combination of DSP, CPU, GPU, Co-Processor, or service-based approaches to satisfy the model in question. These models may act independently or in concert with other models and components of the system as needed. Leveraging an embodiment with DSPs in the CEP layer may allow for more efficient, more real-time, and/or richer results from the models at the discretion of the system operators and designers.

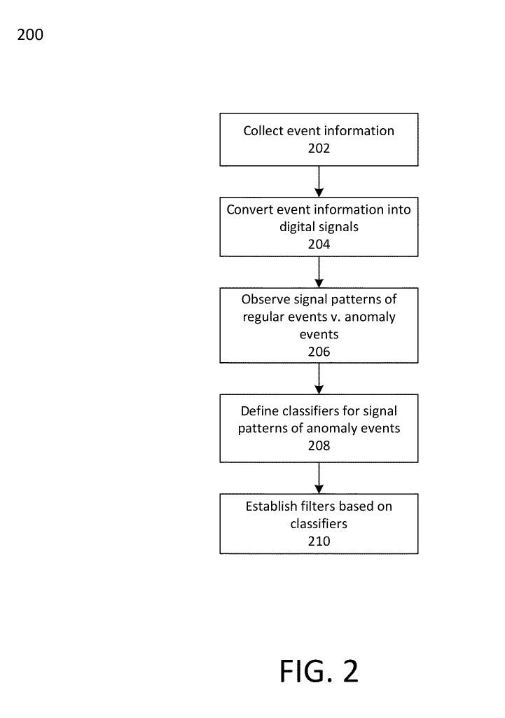

FIG. 2 is a flowchart showing a process 200 for setting up CEP as digital signals according to one embodiment. At step 202, the system may collect event information from various sources. The event data may be streamed from different sources with different formats and contents representing different types of events. The system may receive them through different communication channels. The events may stream in different frequencies and formats depending on the events as they occur in real time.

At step 204, the system may convert event data or information into digital signals. In particular, the event information may be text-based data. The system may convert the text-based info into binary format, digital signals with frequency, and amplitude, but without storing or losing contents. For example, an event information may include a plurality of fields of different data. The system may first extract relevant data from selected fields. Based on the event source and range, types of information, and data fields, the system may extract selected fields that are relevant for encoding. The system may then hash the extracted data into a 32 bit number. This may be accomplished by using hash functions, such as SHA-2 and/or MD5. In an embodiment, the binary format may be normalized to emphasize certain data fields or target areas. As such, text-based data may be converted into digital signals with characteristics of wave-forms, patterns, amplitudes, frequencies, and the like.

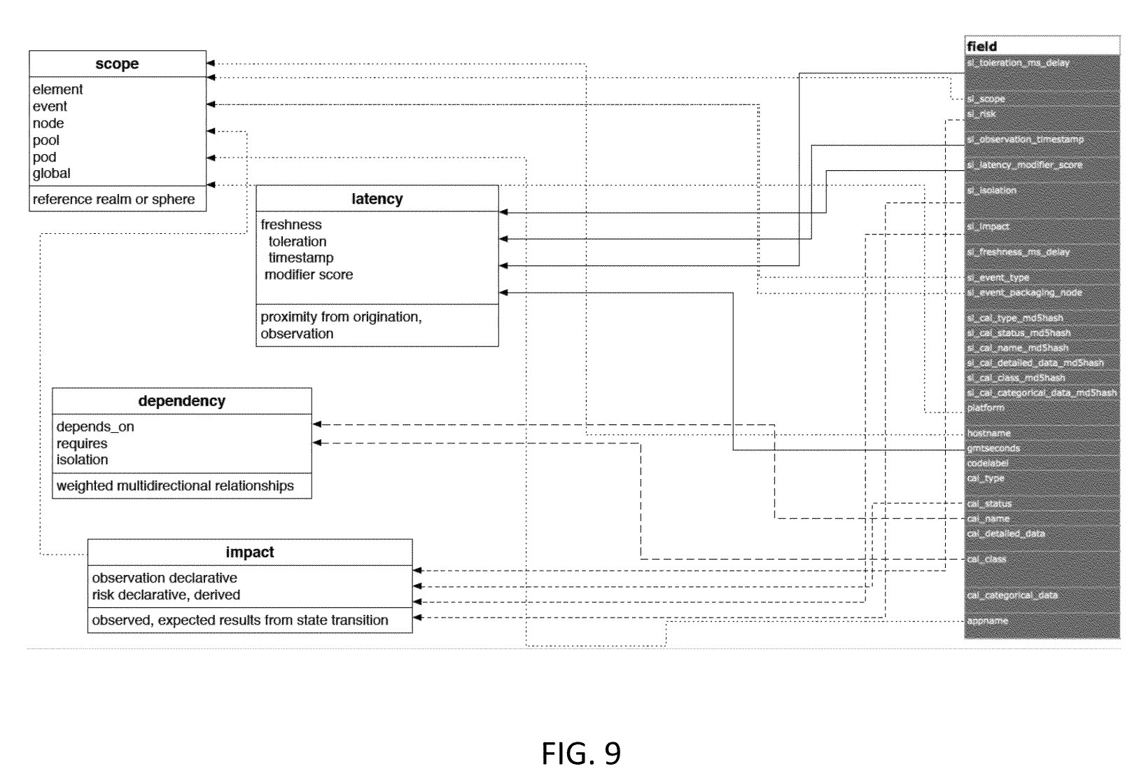

In an embodiment, and using the example from FIG. 9, the system may codify specific text into single precision numeric data (in this case using hexadecimal notation of binary numbers). Each record thus codified is a specific number. Through offline analysis of the stream encoded in this manner, the system may learn the potential range of values for these encoded pieces. For example, consider the case of temperature data from a car radiator and another case of a magazine subjective review of that same car. While both events are describing the same object (the car), the language for those descriptions is very different. And while it is reasonably conceivable that the article might mention radiator temperature, it is not likely to do so as a gauged value of single precision measurements. On the other hand, it is not reasonable to suggest that the temperature gauge from the radiator will ever describe the price, color, or handling of the car. Leveraging this bit of semantic “place,” the system may understand the legitimate range of responses from any particular event.

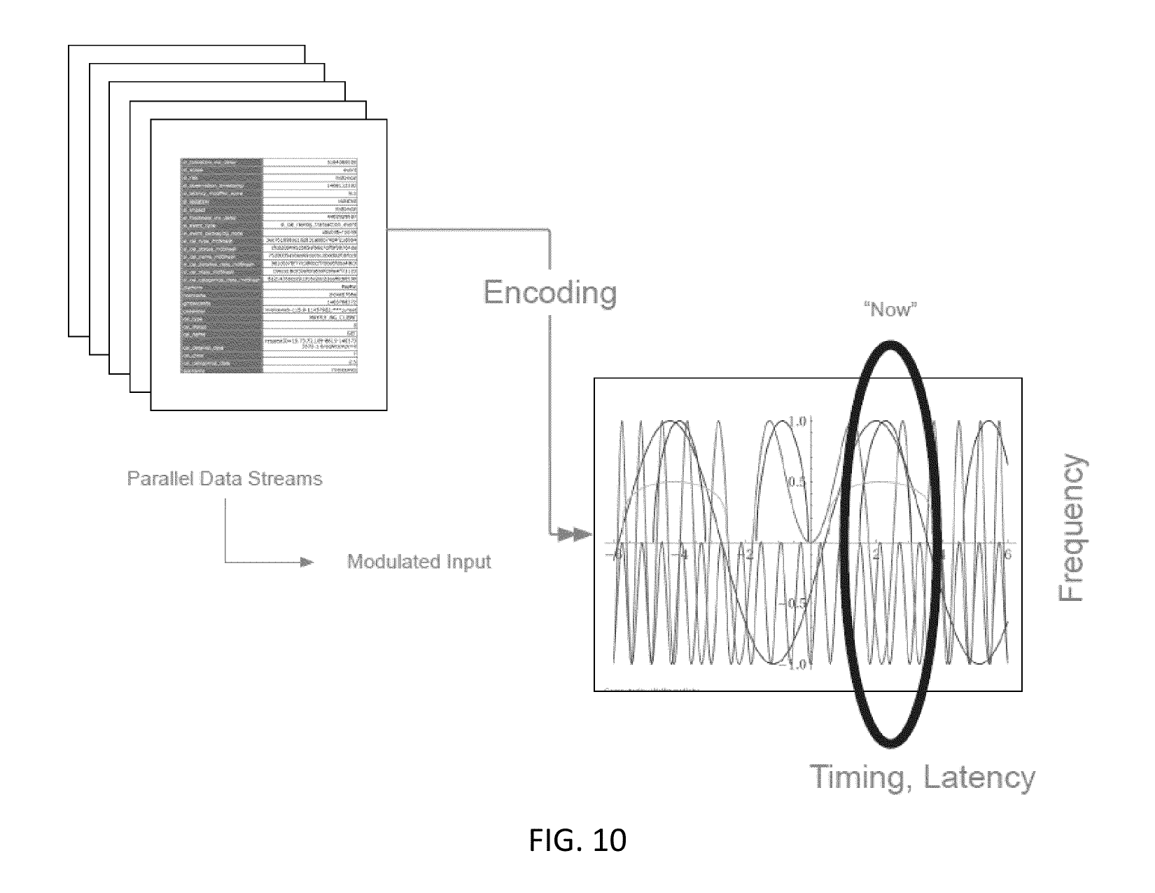

Once understood, events converted to numbers may then be normalized to fit within a specific range, such as within certain “bandwidth” or “amplitude”. Since all events have an associated time series (since by definition an event is an occurrence in time), then all events occur with some degree of discrete (digital) frequency. By normalizing this interval into a continuous range, the system may generate analog frequency by dropping time stamps and emitting events continuously. This may provide the frequency and amplitude required for wave analysis which is common in digital signal processing and may be affected using any number of algorithms for different purposes. When multiple streams are modulated together using frequency ranges (which themselves may be scaled to match one another regardless of discrete timing), the system may analyze several streams at once. FIG. 10 illustrates an example of how this works in an embodiment.

At step 206, the signal patterns resulted from the conversion may be observed and analyzed. In particular, the signals and behaviors of events may be studied to determine patterns and trends. For example, for a payment transaction event at a merchant, the system may monitor and observe the signal patterns and trends of plurality of payment transactions. Purchases of $5 or more may have a certain signal pattern, purchases of $100 or more may have another signal pattern, purchases made with credit cards may have one signal pattern, purchases made with cash may have another signal pattern. In an embodiment, the system may monitor transactions to study the signal patterns of regular events vs. anomalies.

At step 208, the system may define classifiers or model for filtering the event signal based on observation in step 206. Classifiers may indicate features, patterns, or trends of signals from particular type of events. Based on the kind of event, users or operators may define certain type of events that need to be identified. At step 210, the system may establish DSP filters based on the classifiers for filtering the particular type of events. By using the above process 200, DSP filters may be established for identifying or filtering particular types of event signals. In particular, based on the type of events that need to be identified, the DSP filter may be customized to capture such type of event in real time.

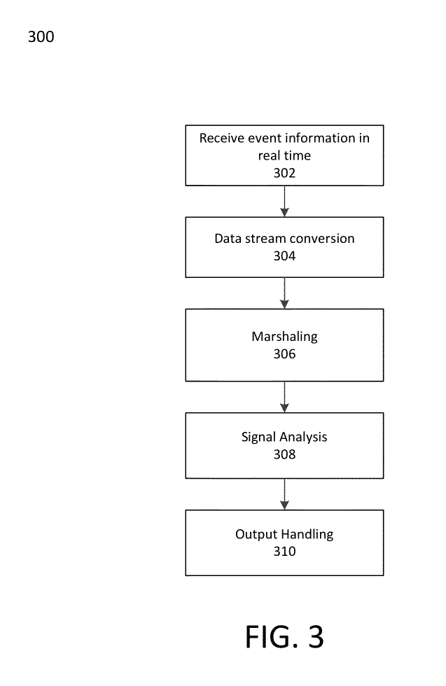

FIG. 3 is a flowchart showing a process for complex event processing using digital signal processors according to one embodiment. At step 302, event data or event information may be received and streamed in real time by data analytics server 10. The data events may come from a plurality of different event sources, such as application logs, machine data, environmental data, and social media. The data events may be streamed in from a plurality of different communication channels in different formats.

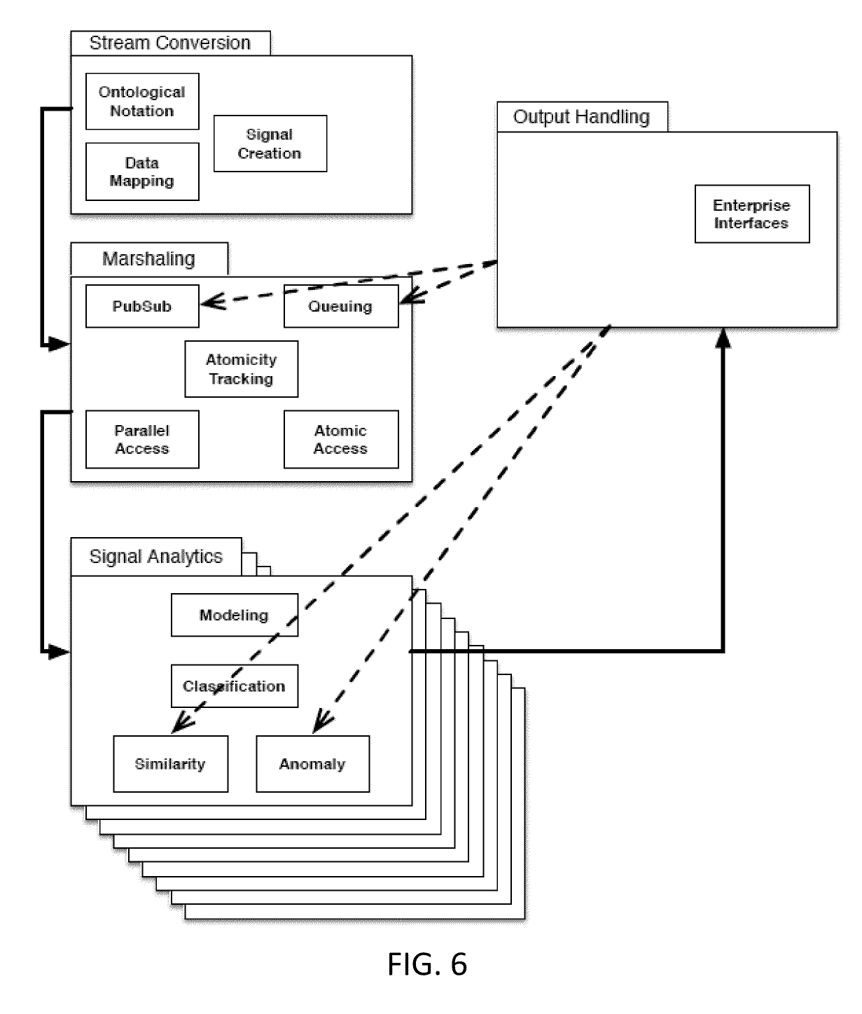

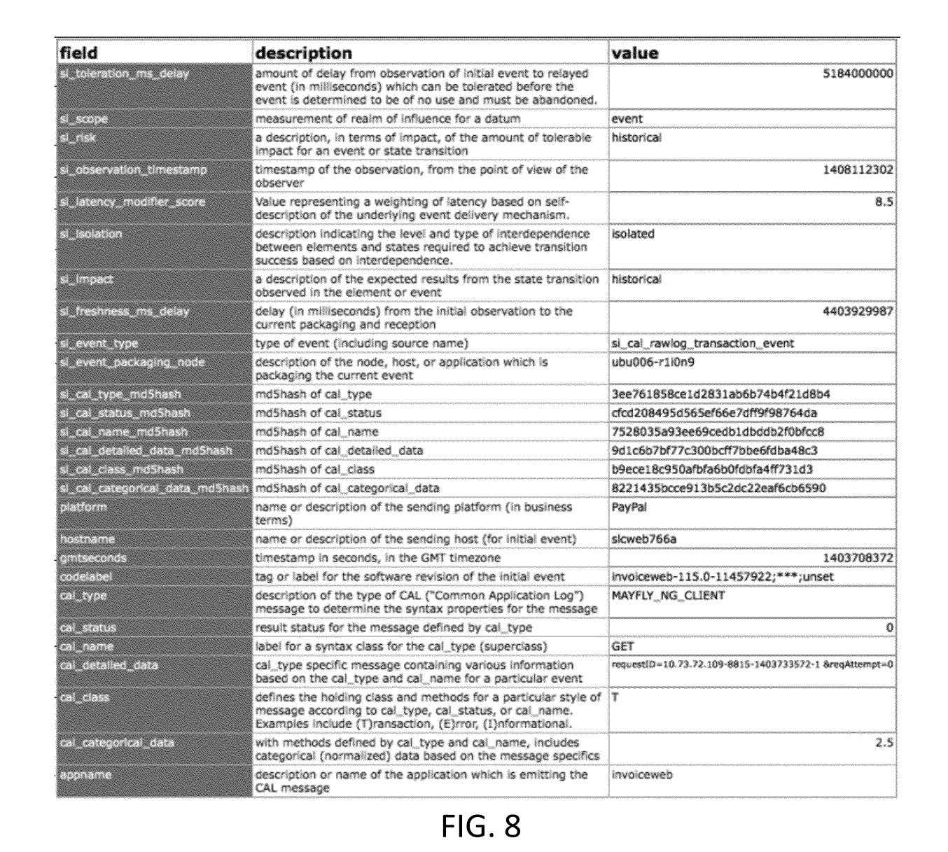

At step 304, the system may process the received event data in a stream conversion process. The stream conversion process may include ontological notation, data mapping, and signal creation, as shown in FIG. 6. In ontological notation, each event received may be given an index number or sequence ID. In data mapping, each event data may be data mapped to identify and extract relevant data fields. As shown in FIG. 8, a portion of an exemplary event data may include various data fields each containing different information. For example, fields regarding scope, latency, impact, and dependency related information. In signal creation, relevant data or information may be converted into digital signals. In particular, a digital signal may be created from these different data by converting the text-based data to binary format by hash functions and the like. In FIG. 9, an exemplary event from an application logging system called “Common Application Log” (CAL) is depicted. Although, the CAL data is specific to a particular application, the CAL data may be used to demonstrate the type of data conversion that may be implemented to convert data to leverage functions of Digital Signal Processor (DSP). For example, the system may convert a message which logs a string of text: “requestID=10.73.72.109-8815-1403733572-1&reqAttempt=0” using md5 hash 9d1c6b7bf77c300bcff7bbe6fdba48c3 to give us a hexadecimal number. This number (decimal 208836359689755278321740910155357898947) may be represented in a bandwith range which contains it and can be matched, filtered, augmented as needed by DSP algorithms.

Combining additional data about the event including timestamp and delay information may allow the system to locate this discrete event on a timeline with other similar events. Analyzing this timeline may allow the system to derive a frequency (for example, if there are 1000 similar events in a minute, then the system may use a frequency of 0.27 events/sec) and map this discrete event into such a range with an amplitude of 208836359689755278321740910155357898947.

Combining many similar and dissimilar events for analysis at the same time may allow the system to use modulation to combine dissimilar frequencies and amplitudes in the same algorithms and thereby compare unlike events without regard to originating context. By retaining a unique identifier (For example, in FIG. 9, this identifier is the hashed combination of si_observation_timestamp, hostname, and si_cal_detailed_data_md5hash: d816a83b4d23a85b6f3eddd257a0f8d2) as processing the stream takes place, anomalies may be handed directly to systems responsible for taking action on events which match filtering criteria.

In FIG. 10, the system may receive multiple event streams from different sources and context in parallel and may analyze characteristics both within and across the streams simultaneously. Different frequencies and amplitude ranges are depicted in FIG. 10 to demonstrate how different streams may appear to DSP algorithms in the system under analysis.

At step 306, the system may execute marshaling for handling the stream of event data. This may include publish-subscribe and queuing to selectively publish or queue particular events for access by output handling, as shown in FIG. 6. Atomicity tracking may be utilized to keep track of particular events such that when a digital signal is of interest, the corresponding event may be identified by the previous ontological notation. Parallel access and/or atomic access also may be implemented.

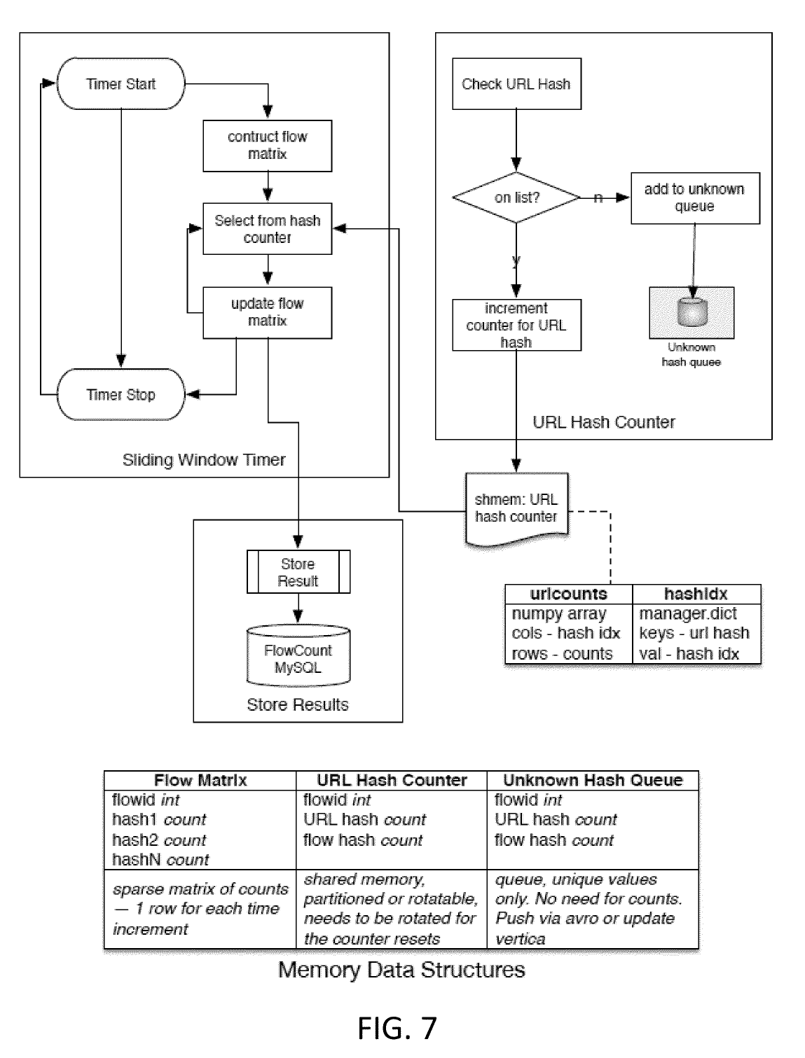

Referring to FIG. 7, examples of a sliding window timer and URL hash counter may be used to process the incoming event data. Due to the relative large volume of incoming data events, the event data may be processed in large batches based on a sliding window timer. A set of counter and flow matrix may be utilized for sequencing a batch of events periodically, e.g., every 5 minutes. Accordingly, the hash counter and hash functions may utilize the sequencing of the sliding window timer.

The sliding window timer may provide a window that moves according to a timer, such as a one-minute timer, so that when looking through the window, the last one minute of data stream may be seen or captured. In particular, the system may maintain a list of patterns to match in a matrix which is organized by patterns (columns) and time (rows). As the system scan the stream of data patterns, the system may watch the stream and increment counters when patterns are matched and do so utilizing a rolling time window such that new entries are made a Time0 and the system may clear entries which are older than the window (Time 0-60 if the system uses second granularity for a 1 minute window).

The sliding window timer 710 begins when the timer starts at 712. The sliding window timer 710 may construct flow matrix at step 714. At step 716, the sliding window timer 710 may select from hash counter. At step 718, the sliding window timer 710 may update flow matrix. The process may return to step 716 until the timer stop at step 720. The results are stored in result store 732 and FlowCount MySQL 734 at the store results step 730.

The URL hash counter 740 begins at step 742 for checking URL hash. At step 744, the URL hash counter checks whether the hash is on the list. If not, the hash is added to the unknown hash queue 748 at step 746. If the hash is on the list, the counter for the URL hash is incremented at step 750. The hash counter is communicated to the sliding window timer 710. Exemplary memory data structures 70 may include flow matrix, URL hash counter, and unknown hash queue.

In an embodiment, the system may take a largely pragmatic approach to data marshaling from the source data sets into the DSP solution. This means that the system may consider the latency, source ingress location, and source native data format as primary considerations in choosing mechanisms for marshaling. The system may maintain the DSP analysis as an event streaming topology however, leveraging messaging for all steps regardless of source container format. For example, one of the first sources (CAL logs) the system analyzes may come to the system as a series of millions of small files organized loosely by directory structure and governed by a proprietary format which may be converted prior to consumption. Since the system includes an ingest stage to convert the data, the system may perform data encoding and eventing simultaneously, forwarding into the messaging systems to move events from source location and provide them as consumable events simultaneously. The system may leverage the Apache Flume source-sink-channel mechanism for moving data, coupled with the Apache Avro serialization format for events, specified by the Systems Intelligence event ontology schema.

At step 308, the system may execute signal analytics to analyze the digital signals of the respective events. Signal analytics may include modeling, classification, signal filtering, identifying similarity and/or anomaly as shown in FIG. 6. As noted above, by identifying similarity and anomaly in signal patterns and/or trends, models or classifiers that may be used to identify signals of types or anomaly of events may be established. These may be used to set up digital filters for identifying similarities and/or anomaly in digital signals. In an embodiment, each data event receiving channel may have a particular DSP filter for identifying similarities and/or anomaly of event streams coming through the channel in real time. In some embodiments, multiple filters may be used for one channel to identify multiple types of anomalies. In some embodiments, signals from different channels may be combined and pass through one DSP filter. Likewise, embodiments can sequence data to one another, allowing for looping structures and augmentation through multiple filter tiers.

At step 310, the system may execute output handling. In particular, the results of the signal analytics may identify events that have similarity or events that are anomalies. These events may then be flagged for more in-depth analysis later. In an embodiment, notifications or warnings may be generated and forwarded to relevant parties via enterprise interfaces.

By using the above process 300, CEP may be implemented in real time as digital signals by leveraging signal processing capabilities of digital signal processors. The process may be implemented readily using familiar systems for easy integration (ARM). For example, Linux systems may be used for general purpose work for easy integration with enterprise systems interfaces (databases, marshaling, command & control) in order to have short development learning curve (python, java, openCL, open MP/MPI). In some embodiments, the system utilizes efficient, real-time parallel processing by implementing signal analysis in hardware to solve encoding, marshaling, and atomicity. This may apply both global shared memory and scale-out process best practices and leverage cross-platform development to decrease ramp-up and testing time (openCL).

The system also may implement parallel, true real-time analytics, such as multiple filters/atomic event stream, multiple streams/filter, multiple filters/multiple streams, pattern recognition (outliers, clusters, frequency matrices, etc.), and a rich library of available functions (notch/high pass/low pass filters, DFT/FFT, z-transform, bilinear transform, and any other signal processing functions.) The system may enable and improve HPC and enterprise practices, such as multicore implementation, tiered shared memory and queuing, high-speed, low-latency transports inter/intra SoC (hyperlink, sRIO, Ethernet), support for common development libraries and standards (openCL, open MP/MPI), efficient, low-power solutions (˜55W/cartridge (4 SoCs per cartridge)), and extreme performance (11.2 GF/watt).

The system may implement and/or realize a world where the past, present, and even future predictions about a user may be shown on the heads-up display in the user's contact lenses at the moment the user is looking at them. Augmented reality systems may provide something very similar to this idea. The same idea may be implemented for big data problems. In traditional enterprise businesses, a decision is made from the outset as to whether a particular solution will look at data from a historical, immediate, or predictive perspective. With the ability to gain true real time analysis, the system may enable the utilization of all three perspectives simultaneously in real time.

On receiving an event into the complex event processing system, the system may disaggregate the needed information for performing pattern recognition from the specific data which describes a particular, unique event. The system may leverage digital signal processing hardware to perform anomaly detection and pattern recognition to allows the system to have a sharper focus, and a more in-depth analysis in a shorter period of time because the system may devote more resources to the details of the work and offload the more repetitive tasks.

The following are exemplary scenarios in which the above processes may be implemented.

Traditionally, payment transactions processed by a payment service provider, such as PayPal Inc., requires various authentication and verification processes to complete. For example, if A is paying B $5 via the payment service provider at certain time and date using a mobile device, the payment service provider must first authenticate the payment request from A and the payment deposit at B. The process may include verifying payment amount, currency, payment nationality, and the like. With the recent anti-money laundering policies and regulations, the process of money transferring transactions also becomes more tedious with multiple layers of security checks to prevent fraud and money laundering. With millions of transactions processed by the payment service provider each day, this may become a huge undertaking and may cause transaction delays for users.

Complex event processing as digital signals may allow analysis of large volumes of transaction events to detect fraud, identify trends, and other data analysis. For example, the payment transaction events may first be converted into digital signals by hash functions or other means. The digital signals may be passed through a digital signal processing device with algorithms designed to filter and identify trends and/or anomalies. For example, one filter may identify digital signal patterns indicating transactions with high-risk of fraud and another filter may identify digital signal patterns indicating certain type of purchase for marketing purposes. Thus, payment transactions may be analyzed in real-time by leveraging the hardware capabilities of digital signal processing devices.

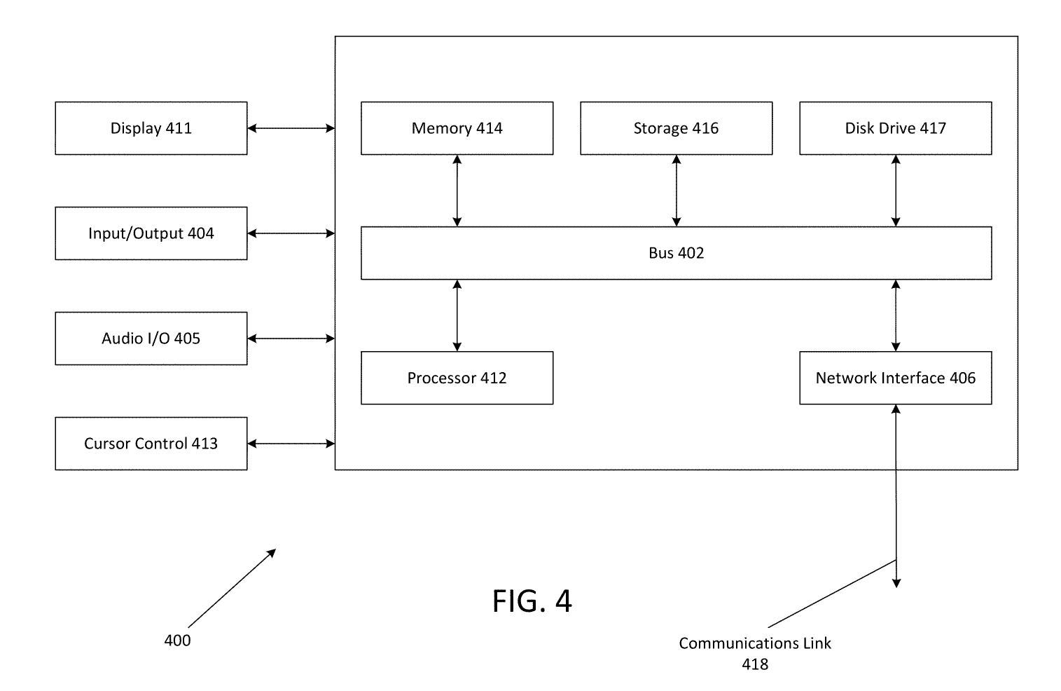

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a communication module configured to receive event data;
a data conversion module configured to convert the event data into digital signals; and
a digital signal processing device configured to screen the digital signals to determine a type of the event data.

2. The system of claim 1, wherein the event data is streamed to the communication module and the digital signal processing device is configured to screen the event data in real time as the event data is streamed.

3. The data analytics device of claim 1,
wherein the communication device is configured to receive a plurality of event data streams from a plurality of sources via a plurality of channels;
wherein the digital signal processing device is configured to apply signal filters or algorithms to screen the plurality of event data streams.

4. The system of claim 3, wherein the filters or the algorithms of the digital signal processing device comprise one or more of a high pass filter, a low pass filer, a notch filter, a Discrete Fourier Transform function, a Fast Fourier Transform function, and a z-transform function, a bilinear transform function, and a sliding window counter.

5. The system of claim 1, wherein the digital signal processing device comprises one or more of a digital signal processor, a graphics processing unit (GPU), a field programmable gate array (FPGA), a coprocessor, and a central processing unit.

6. The system of claim 1, wherein the digital signal processing device comprises filters configured to identify anomalies in the event data.

7. The system of claim 6, wherein the anomalies are associated with errors or frauds in financial transactions.

8. The system of claim 1, wherein the data conversion module is configured to convert the event data from text-based data into numeric data by hash functions.

9. The system of claim 1, wherein the digital signal processing device comprises filters configured to identify similarities in the event data.

10. The system of claim 9, wherein the similarities are associated with trends of events including one or more of market trends, business trends, environmental trends, and social media trends.

11. A method comprising:
receiving, by a communication module, event data;
converting, by a data conversion module, the event data into digital signals; and
screening, by a digital signal processing device, the digital signals to determine a type of the event data.

12. The method of claim 11, wherein the event data is one or more of application logs, machine data, environmental data, and social media data.

13. The method of claim 11 further comprising:
analyzing, by one or more processors, patterns of the digital signals;
determining, by the one or more processors, classifiers in the digital signals associated with anomalies in the event data; and
constructing, by the digital signal processing device, filters for identifying the anomalies in the event data based on the classifiers.

14. The method of claim 11 further comprising:
analyzing, by one or more processors, patterns of the digital signals;
determining, by the one or more processors, patterns of the digital signals associated with trends in the event data; and
constructing, by the digital signal processing device, filters for identifying the trends.

15. The method of claim 11 further comprising:
assigning, by one or more processors, an unique identification to each of a plurality of data objects in the event data;
converting, by the one or more processors, the event data from text-based data into binary based data by hash functions; and
tracking, by the one or more processors, each of the plurality of data object based on the unique identification assigned to each data object.

16. The method of claim 11, further comprising:
selecting, by one or more processors, relevant data fields from the event data;
extracting, by the one or more processors, relevant data from the relevant data fields; and
converting the extracted relevant data into digital signals.

17. The method of claim 11,
wherein the event data comprises a plurality of data streams received via a plurality of communication channels, and
wherein the plurality of data streams are passed through and screened by a plurality of different filters of the digital signal processing device.

18. The method of claim 11,
wherein the event data comprises a plurality of data streams received via a plurality of communication channels, and
wherein the plurality of data streams are combined and screened by a particular filter of the digital signal processing device.

19. The method of claim 11, wherein the event data comprises data related to financial transactions and the digital signal processing device comprises filters configured to identify anomalies in the financial transactions, and the method further comprising:
identifying, by the digital signal processing device, anomalies in the financial transactions;
flagging, by one or more processors, the anomalies for analysis; and
analyzing, by the one or more processors, the anomalies to determine a type of anomalies.

20. The method of claim 11, wherein the event data comprises data related to financial transactions and the digital signal processing device comprises filters configured to identify trends in the financial transactions, and the method further comprising:
identifying, by the digital signal processing device, trends in the financial transactions;
analyzing, by the one or more processors, the trends of the financial transactions; and
forecasting, by the one or more processors, future financial transactions based on the trends.
